(19) United States
(12) Patent Application Publication
(10) Pub. No.: US 2006/0099368 A1
(43) Pub. Date: May 11, 2006

(54) Fuel hose with a fluoropolymer inner layer

(76) Inventor: Edward Hosung Park, Saline, MI (US)

Correspondence Address: FREUDENBERG-NOK GENERAL PARTNERSHIP;LEGAL DEPARTMENT, 47690 EAST ANCHOR COURT, PLYMOUTH, MI, 48170-2455, US

(21) Appl. No.: 10/983,947

(22) Filed: Nov. 8, 2004

(51) Int. Cl. F16L 11/04

(52) U.S. Cl. 428/36.91; 428/421; 428/422; 428/521; 428/522; 428/475.5; 428/323; 264/105; 264/495; 264/483; 264/485; 264/173.16

(57) ABSTRACT

A multilayer fuel line having a fluoropolymer inner layer of a continuous polymeric phase and a dispersed phase of conductive particulate provides electrical resistivity for avoiding electrical charge buildup from fuel flow within the fuel line. Fluoroelastomer fluoropolymer inner layers also provide flexibility and compressive sealing against rigid tubes connected to the multi-layer fuel line. In one approach electron beam radiation is used to cure the inner layer.

### INTRODUCTION

This invention relates to a fuel hose (fuel line) having an inner layer formed from an admixture of a fluoropolymer and dispersed conductive particulate so that static charge buildup will not occur on the inner layer of the fuel hose.

Fluoropolymers are well known for providing good chemical resistance and toughness in many different applications. Fluoroelastomer fluoropolymers also provide elasticity in derived articles with commensurate mechanical robustness and also excellent compressive sealing against the surface of another article. Thermoplastic elastomer (TPE) and thermoplastic vulcanizate (TPV) materials combine properties of thermoplastics and properties of elastomers. In this regard, TPE and TPV materials are usually multi-phase mixtures of elastomer (vulcanizate) in thermoplastic; the TPE providing multi-phase characteristics at the molecular level as a block copolymer of elastomer and thermoplastic, and the TPV providing a multi-phase polymeric admixture of at least one agglomerated elastomer (vulcanizate) phase and at least one agglomerated thermoplastic plastic phase which are admixed to co-exist as a dispersion of one phase in the other. Heating to above the melting point enabled by the thermoplastic phase of either the agglomerated dispersive phase admixture or block copolymer liquefies either the TPV or the TPE, respectively.

The chemical resistance, toughness, and elasticity of fluoroelastomer and fluoropolymers and the thermoplastic aspect of TPE and TPV mixtures incorporating fluoroelastomers is of great value in forming desired articles. However, one of the drawbacks of items made from these materials is that electrical charge can build up on the surface of the article. This charge buildup can be hazardous if the article is in service in applications or environments where flammable or explosive materials are present. Such a situation is very possible when a fuel hose is made of a fluoroelastomer, fluoropolymer, or a TPE or TPV incorporating a fluoroelastomer.

A fuel hose of fluoroelastomer, fluoropolymer, or TPE or TPV mixture incorporating a fluoroelastomer is, however, otherwise desirable because of the previously-outlined properties of these materials and because an end of a fuel line having an elastomer inner layer can readily slide over the end of a rigid tube and then compressively adhere to that rigid tube with elastic compression.

What is needed is a way for fuel hoses to be made of a fluoroelastomer, fluoropolymer, fluoroelastomer-based TPE, or TPV admixture incorporating a fluoroelastomer such that the fuel hose will not retain electrical charge. This and other needs are achieved with the invention.

### SUMMARY

The invention is for a multilayer fuel line having an inlet end, an outlet end, and a flow axis between the inlet end and the outlet end, the fuel line comprising:

(a) a fluoropolymer inner layer extending along the flow axis from the inlet end to the outlet end, the inner layer having electrical resistivity of less than about of 1×10⁻³ Ohm-m at 20 degrees Celsius (the inner layer having an outside surface); and

(b) a polymeric outer structural layer adhered to the outside surface of the inner layer.

In yet another aspect the fluoropolymer inner layer comprises:

(i) a continuous polymeric phase; and

(ii) a dispersed phase of conductive particulate where the dispersed phase comprises a plurality of conductive particles dispersed in the continuous polymeric phase.

In another aspect the fluoropolymer inner layer comprises polymer of any of fluoroelastomer vulcanized to provide a compressive set value from about 5 to about 100 percent of a mathematical difference between a non-vulcanized compressive set value for the fluoroelastomer and a fully-vulcanized compressive set value for the fluoroelastomer, fluoroelastomer thermoplastic vulcanizate vulcanized to provide a compressive set value from about 5 to about 100 percent of a mathematical difference between a non-vulcanized compressive set value for the fluoroelastomer of the fluoroelastomer thermoplastic vulcanizate and a fully-vulcanized compressive set value for the fluoroelastomer of the fluoroelastomer thermoplastic vulcanizate, fluoroelastomer-based thermoplastic elastomer vulcanized to provide a compressive set value from about 5 to about 100 percent of a mathematical difference between a non-vulcanized compressive set value for the thermoplastic elastomer and a fully-vulcanized compressive set value for the thermoplastic elastomer, and a blend of fluoroelastomer precursor gum and thermoplastic where the precursor gum has a glass transition temperature, a decomposition temperature, a Mooney viscosity of from about 0 to about 150 ML₁₊₁₀ at 121 degrees Celsius, and, at a temperature having a value that is not less than the glass transition temperature and not greater than the decomposition temperature, a compressive set value from about 0 to about 5 percent of a mathematical difference between a non-vulcanized compressive set value for fluoroelastomer derived from the fluoroelastomer precursor gum and a fully-vulcanized compressive set value for the derived fluoroelastomer.

In one aspect, the fluoroelastomer is of any of

(i) vinylidene fluoride/hexafluoropropylene copolymer fluoroelastomer having from about 66 weight percent to about 69 weight percent fluorine and a Mooney viscosity of from about 0 to about 130 ML₁₊₁₀ at 121 degrees Celsius,

(ii) vinylidene fluoride/perfluorovinyl ether/tetrafluoroethylene terpolymer fluoroelastomer having at least one cure site monomer and from about 64 weight percent to about 67 weight percent fluorine and a Mooney viscosity of from about 50 to about 100 ML₁₊₁₀ at 121 degrees Celsius,

(iii) tetrafluoroethylene/propylene/vinylidene fluoride terpolymer fluoroelastomer having from about 59 weight percent to about 63 weight percent fluorine and a Mooney viscosity of from about 25 to about 45 ML₁₊₁₀ at 121 degrees Celsius,

(iv) tetrafluoroethylene/ethylene/perfluorovinyl ether terpolymer fluoroelastomer having at least one cure site monomer and from about 60 weight percent to about 65 weight percent fluorine and a Mooney viscosity of from about 40 to about 80 ML₁₊₁₀ at 121 degrees Celsius,

(v) vinylidene fluoride/hexafluoropropylene/tetrafluoroethylene terpolymer fluoroelastomer having at least one cure site monomer and from about 66 weight percent to about 72.5 weight percent fluorine and a Mooney viscosity of from about 15 to about 90 ML₁₊₁₀ at 121 degrees Celsius,

(vi) tetrafluoroethylene/propylene copolymer fluoroelastomer having about 57 weight percent fluorine and a Mooney viscosity of from about 25 to about 115 ML₁₊₁₀ at 121 degrees Celsius,

(vii) tetrafluoroethylene/ethylene/perfluorovinyl ether/vinylidene fluoride tetrapolymer fluoroelastomer having at least one cure site monomer and from about 59 weight percent to about 64 weight percent fluorine and a Mooney viscosity of from about 30 to about 70 ML₁₊₁₀ at 121 degrees Celsius,

(viii) tetrafluoroethylene/perfluorovinyl ether copolymer fluoroelastomer having at least one cure site monomer and from about 69 weight percent to about 71 weight percent fluorine and a Mooney viscosity of from about 60 to about 120 ML₁₊₁₀ at 121 degrees Celsius, fluoroelastomer corresponding to the formula
[—TFE_{q}—HFPᵣ—VdFₛ—]d

and

(ix) combinations thereof,

where TFE is essentially a tetrafluoroethyl block, HFP is essentially a hexfluoropropyl block, and VdF is essentially a vinylidyl fluoride block, and products qd and rd and sd collectively provide proportions of TFE, HFP, and VdF whose values are within element 101 of FIG. 1.

In another aspect the fluoropolymer inner layer is cured from fluoropolymer precursor of any of fluoroelastomer, fluoroelastomer thermoplastic vulcanizate, or fluoroelastomer thermoplastic elastomer vulcanized as noted above.

In one aspect the fluoropolymer inner layer is derived from radiation curing of a fluoropolymer precursor and the radiation is of any of ultraviolet radiation, infrared radiation, ionizing radiation, electron beam radiation, x-ray radiation, an irradiating plasma, a discharging corona, and a combination of these.

In yet another aspect, the fluoropolymer inner layer is derived from curing fluoroelastomer with a curing agent of any of a peroxide, a bisphenol, and a combination of these.

In one aspect, the conductive particulate is of any of conductive carbon black, conductive carbon fiber, conductive carbon nanotubes, conductive graphite powder, conductive graphite fiber, bronze powder, bronze fiber, steel powder, steel fiber, iron powder, iron fiber, copper powder, copper fiber, silver powder, silver fiber, aluminum powder, aluminum fiber, nickel powder, nickel fiber, wolfram powder, wolfram fiber, gold powder, gold fiber, copper-manganese alloy powder, copper-manganese fiber, and combinations thereof.

In yet another aspect the polymeric outer structural layer comprises structural polymer of any of acrylic acid ester rubber/polyacrylate rubber thermoplastic vulcanizate acrylonitrile-butadiene-styrene, amorphous nylon, cellulosic plastic, ethylene chlorotrifluoroethylene, epoxy resin, ethylene tetrafluoroethylene, ethylene acrylic rubber, ethylene acrylic rubber thermoplastic vulcanizate, ethylene-propylene-diamine monomer rubber/polypropylene thermoplastic vulcanizate, tetrafluoroethylene/hexafluoropropylene, fluoroelastomer, fluoroelastomer thermoplastic vulcanizate, fluoroplastic, hydrogenated nitrile rubber, melamine-formaldehyde resin, tetrafluoroethylene/perfluoromethylvinyl ether, natural rubber, nitrile butyl rubber, nylon, nylon 6, nylon 610, nylon 612, nylon 63, nylon 64, nylon 66, perfluoroalkoxy (tetrafluoroethylene/perfluoromethylvinyl ether), phenolic resin, polyacetal, polyacrylate, polyamide, polyamide thermoplastic, thermoplastic elastomer, polyamide-imide, polybutene, polybutylene, polycarbonate, polyester, polyester thermoset plastic, polyesteretherketone, polyethylene, polyethylene terephthalate, polyimide, polymethylmethacrylate, polyolefin, polyphenylene sulfide, polypropylene, polystyrene, polysulfone, polytetrafluoroethylene, polyurethane, polyurethane elastomer, polyvinyl chloride, polyvinylidene fluoride, ethylene propylene dimethyl/polypropylene thermoplastic vulcanizate, silicone, silicone-thermoplastic vulcanizate, thermoplastic polyurethane, thermoplastic polyurethane elastomer, thermoplastic polyurethane vulcanizate, thermoplastic silicone vulcanizate, thermoplastic urethane, thermoplastic urethane elastomer, tetrafluoroethylene/hexafluoropropylene/vinylidene fluoride, polyamide-imide, and combinations thereof.

In yet another aspect, essentially all of the conductive particles independently have a cross-sectional diameter from about 0.1 micron to about 100 microns.

In yet another aspect, the inner layer further comprises filler of any of fiberglass particulate, inorganic fiber particulate, carbon fiber particulate, ground rubber particulate, polytetrafluorinated ethylene particulate, microspheres, carbon nanotubes, and combinations thereof.

In another aspect, the invention is for a method for making a fuel line, the fuel line having an inlet end, an outlet end, and a flow axis between the inlet end and the outlet end, the method comprising:

(a) admixing fluoropolymer with conductive particulate to form a conductive fluoropolymer admixture;

(b) providing a structural polymer for the fuel line; and

(c) co-extruding the structural polymer and the fluoropolymer admixture into a multilayer tube having an inner layer of the fluoropolymer admixture and an outer layer of the structural polymer; where

(d) the admixing admixes sufficient conductive particulate such that the inner layer has, after the curing, electrical resistivity of less than about of 1×10⁻³ Ohm-m at 20 degrees Celsius.

In one aspect the invention cures the inner layer with radiation as discussed above.

In another aspect the invention cures the inner layer by admixing, prior to the co-extruding, a curing agent into the fluoropolymer admixture where the curing agent is of any of a peroxide, a bisphenol, and a combination of these.

In one aspect, the conductive particles are coated with a coating to provide coated conductive particles as the conductive particulate, the conductive particles having a first surface tension between the conductive particles and the fluoropolymer, the coated conductive particles having a second surface tension between the coated conductive particles and the fluoropolymer with the second surface tension being less than the first surface tension.

In one aspect, the admixing is achieved with any of batch polymer mixer, a roll mill, a continuous mixer, a single-screw mixing extruder, and a twin-screw extruder mixing extruder.

The invention is also for a fuel line made by a process according to the previously mentioned methods.

Further areas of applicability will become apparent from the detailed description provided hereinafter. It should be understood that the detailed description and specific examples, while indicating embodiments of the invention, are intended for purposes of illustration only and are not intended to limit the scope of the invention.

### BRIEF DESCRIPTION OF THE DRAWINGS

The present invention will become more fully understood from the detailed description and the accompanying drawings of FIGS. 1 to 3.

FIG. 1 presents a ternary composition diagram for tetrafluoroethylene (TFE), hexfluoropropylene (HFP), and vinylidene fluoride blends;

FIG. 2A shows detail in a fuel hose;

FIG. 2B shows a cross-sectional view of a two layer fuel hose;

FIG. 2C shows a cross-sectional view of a three layer fuel hose; and

FIG. 3 shows a coextrusion process for making a multilayer fuel hose.

It should be noted that the figures set forth herein are intended to exemplify the general characteristics of an apparatus, materials, and methods among those of this invention, for the purpose of the description of such embodiments herein. The figures may not precisely reflect the characteristics of any given embodiment, and are not necessarily intended to define or limit specific embodiments within the scope of this invention.

### DESCRIPTION

The following definitions and non-limiting guidelines must be considered in reviewing the description of this invention set forth herein.

The headings (such as “Introduction” and “Summary”) and sub-headings used herein are intended only for general organization of topics within the disclosure of the invention, and are not intended to limit the disclosure of the invention or any aspect thereof. In particular, subject matter disclosed in the “Introduction” may include aspects of technology within the scope of the invention, and may not constitute a recitation of prior art. Subject matter disclosed in the “Summary” is not an exhaustive or complete disclosure of the entire scope of the invention or any embodiments thereof.

The citation of references herein does not constitute an admission that those references are prior art or have any relevance to the patentability of the invention disclosed herein. All references cited in the Description section of this specification are hereby incorporated by reference in their entirety.

The description and specific examples, while indicating embodiments of the invention, are intended for purposes of illustration only and are not intended to limit the scope of the invention. Moreover, recitation of multiple embodiments having stated features is not intended to exclude other embodiments having additional features, or other embodiments incorporating different combinations the stated of features.

As used herein, the words “preferred” and “preferably” refer to embodiments of the invention that afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the invention.

As used herein, the word “include,” and its variants, is intended to be non-limiting, such that recitation of items in a list is not to the exclusion of other like items that may also be useful in the materials, compositions, devices, and methods of this invention.

Most items of manufacture represent an intersection of considerations in both mechanical design and in materials design. In this regard, improvements in materials frequently are intertwined with improvements in mechanical design. The embodiments describe compounds, compositions, and a fuel hose (fuel line) that enable improvements in polymer material synthesis to be fully exploited.

The examples and other embodiments described herein are exemplary and not intended to be limiting in describing the full scope of compositions and methods of this invention. Equivalent changes, modifications and variations of specific embodiments, materials, compositions and methods may be made within the scope of the present invention, with substantially similar results.

As referred to herein, the terms “fuel hose” and “fuel line” include any conduit for a volatile hydrocarbon liquid. In a preferred embodiment, the liquid is operable as a fuel for a combustion process, such as gasoline, diesel or similar hydrocarbon fuel. In various embodiments, combustion processes include those of an internal combustion engine and hydrocarbon reforming.

Preferred fuel hose embodiments have an inner layer made of electrically conductive fluoropolymer material. In this regard, details in electrically conductive fluoropolymer materials for use in the embodiments are first discussed.

Carbon-chain-based polymeric materials (polymers) are usefully defined as falling into one of three traditionally separate generic primary categories: thermoset materials (one type of plastic), thermoplastic materials (a second type of plastic), and elastomeric (or rubber-like) materials (elastomeric materials are not generally referenced as being “plastic” insofar as elastomers do not provide the property of a solid “finished” state). An important measurable consideration with respect to these three categories is the concept of a melting point—a point where a solid phase and a liquid phase of a material co-exist. In this regard, a thermoset material essentially cannot be melted after having been “set” or “cured” or “cross-linked”. Precursor component(s) to the thermoset plastic material are usually shaped in molten (or essentially liquid) form, but, once the setting process has executed, a melting point essentially does not exist for the material. A thermoplastic plastic material, in contrast, hardens into solid form (with attendant crystal generation), retains its melting point essentially indefinitely, and re-melts (albeit in some cases with a certain amount of degradation in general polymeric quality) after having been formed. An elastomeric (or rubber-like) material does not have a melting point; rather, the elastomer has a glass transition temperature where the polymeric material demonstrates an ability to usefully flow, but without co-existence of a solid phase and a liquid phase at a melting point.

Elastomers are frequently transformed into very robust flexible materials through the process of vulcanization. Depending upon the degree of vulcanization, the glass transition temperature may increase to a value that is too high for any practical attempt at liquefaction of the vulcanizate. Vulcanization implements inter-bonding between elastomer chains to provide an elastomeric material more robust against deformation than a material made from the elastomers in their pre-vulcanized state. In this regard, a measure of performance denoted as a “compression set value” is useful in measuring the degree of vulcanization (“curing”, “cross-linking”) in the elastomeric material. For the initial elastomer, when the material is in non-vulcanized elastomeric form, a non-vulcanized compression set value is measured according to ASTM D395 Method B and establishes thereby an initial compressive value for the particular elastomer. Under extended vulcanization, the elastomer vulcanizes to a point where its compression set value achieves an essentially constant maximum respective to further vulcanization, and, in so doing, thereby defines a material where a fully vulcanized compression set value for the particular elastomer is measurable. In applications, the elastomer is vulcanized to a compression set value useful for the application.

Augmenting the above-mentioned three general primary categories of thermoset plastic materials, thermoplastic plastic materials, and elastomeric materials are two blended combinations of thermoplastic and elastomers (vulcanizates) generally known as TPEs and TPVs. Thermoplastic elastomer (TPE) and thermoplastic vulcanizate (TPV) materials have been developed to partially combine the desired properties of thermoplastics with the desired properties of elastomers. As such, TPV materials are usually multi-phase admixtures of elastomer (vulcanizate) in thermoplastic. Traditionally, the elastomer (vulcanizate) phase and thermoplastic plastic phase co-exist in phase admixture after solidification of the thermoplastic phase; and the admixture is liquefied by heating the admixture above the melting point of the thermoplastic phase of the TPV. TPE materials are multi-phase mixtures, at the molecular level, of elastomer and thermoplastic and provide thereby block co-polymers of elastomer and thermoplastic. In this regard, TPEs are co-oligomeric block co-polymers derived from polymerization of at least one thermoplastic oligomer and at least one elastomeric oligomer. TPVs and TPEs both have melting points enabled by their respective thermoplastic phase(s).

Thermoset plastic materials, thermoplastic plastic materials, elastomeric materials, thermoplastic elastomer materials, and thermoplastic vulcanizate materials generally are not considered to be electrically conductive. As such, electrical charge buildup on surfaces of articles made of these materials can occur to provide a “static charge” on a charged surface. When discharge of the charge buildup occurs to an electrically conductive material proximate to such a charged surface, an electrical spark manifests the essentially instantaneous current flowing between the charged surface and the electrical conductor. Such a spark can be hazardous if the article is in service in applications or environments where flammable or explosive materials are present. Rapid discharge of static electricity can also damage some items (for example, without limitation, microelectronic articles) as critical electrical insulation is subjected to an instantaneous surge of electrical energy. Grounded articles made of materials having an electrical resistivity of less than about of 1×10⁻³ Ohm-m at 20 degrees Celsius are generally desired to avoid electrical charge buildup. Accordingly, in one embodiment of a material for a fuel hose embodiment, a dispersed phase of conductive particulate is provided in a fluoropolymer material to provide an electrically conductive fluoropolymeric material having an post-cured electrical resistivity of less than about of 1×10⁻³ Ohm-m at 20 degrees Celsius. This dispersed phase is made of a plurality of conductive particles dispersed in a continuous polymeric phase of fluoropolymer. In this regard, when, in some embodiments, the continuous polymeric phase of fluoropolymer is itself a multi-polymeric-phase polymer blend and/or admixture, the dispersed phase of conductive particles are preferably dispersed throughout the various polymeric phases without specificity to any one of the polymeric phases in the multi-polymeric-phase polymer.

The conductive particles used in alternative embodiments of electrically conductive polymeric materials for the fuel hose embodiments include conductive carbon black, conductive carbon fiber, conductive carbon nanotubes, conductive graphite powder, conductive graphite fiber, bronze powder, bronze fiber, steel powder, steel fiber, iron powder, iron fiber, copper powder, copper fiber, silver powder, silver fiber, aluminum powder, aluminum fiber, nickel powder, nickel fiber, wolfram powder, wolfram fiber, gold powder, gold fiber, copper-manganese alloy powder, copper-manganese fiber, and combinations thereof.

The continuous polymeric phase in one set of alternative embodiments of electrically conductive polymeric materials for the fuel hose embodiments includes a polymer or polymer admixture from a fundamental polymer set of fluoroelastomer vulcanized to provide a compressive set value (as further discussed in the following paragraph) from about 5 to about 100 percent of a mathematical difference between a non-vulcanized compressive set value for the fluoroelastomer and a fully-vulcanized compressive set value for the fluoroelastomer, fluoroelastomer thermoplastic vulcanizate vulcanized to provide a compressive set value (as further discussed in the following paragraph) from about 5 to about 100 percent of a mathematical difference between a non-vulcanized compressive set value for the fluoroelastomer of the fluoroelastomer thermoplastic vulcanizate and a fully-vulcanized compressive set value for the fluoroelastomer of the fluoroelastomer thermoplastic vulcanizate, and fluoroelastomer-based thermoplastic elastomer vulcanized to provide a compressive set value (as further discussed in the following paragraph) from about 5 to about 100 percent of a mathematical difference between a non-vulcanized compressive set value for the thermoplastic elastomer and a fully-vulcanized compressive set value for the thermoplastic elastomer.

With respect to a difference between a non-vulcanized compressive set value for an elastomer and a fully-vulcanized compressive set value for an elastomer, it is to be noted that percentage in the 0 to about 100 percent range respective to a mathematical difference (between a non-vulcanized compression set value respective to a partially-vulcanized elastomer or elastomer gum and a fully-vulcanized compression set value respective to the elastomer) applies to the degree of vulcanization in the elastomer rather than to percentage recovery in a determination of a particular compression set value. As an example, an elastomer prior to vulcanization has a non-vulcanized compression set value of 72 (which could involve a 1000% recovery from a thickness measurement under compression to a thickness measurement after compression is released). After extended vulcanization, the vulcanized elastomer demonstrates a fully-vulcanized compression set value of 10. A mathematical difference between the values of 72 and 10 indicate a range of 62 between the non-vulcanized compression set value respective to the base elastomer and a fully-vulcanized compression set value respective to the base elastomer. Since the compression set value decreased with vulcanization in the example, a compressive set value within the range of 50 to about 100 percent of a mathematical difference between a non-vulcanized compression set value respective to the base elastomer and a fully-vulcanized compression set value respective to the base elastomer would therefore be achieved with a compressive set value between about 41 (50% between 72 and 10) and about 10 (the fully-vulcanized compression set value).

Returning now to specific considerations in the continuous polymeric phase of electrically conductive fluoropolymeric material embodiments for the fuel hose embodiments, a blend of fluoroelastomer precursor gum and thermoplastic provides a gum-enhanced admixture in a further set of alternative electrically conductive fluoropolymeric material embodiments. In this regard, elastomer precursor gum is effectively a low molecular weight post-oligomer precursor for an elastomeric material. More specifically, the fluoroelastomer gum has a glass transition temperature, a decomposition temperature, and, at a temperature having a value that is not less than the glass transition temperature and not greater than the decomposition temperature, a compressive set value (as further described herein) from about 0 to about 5 percent of a mathematical difference between a non-vulcanized compressive set value for elastomer derived from the elastomer precursor gum and a fully-vulcanized compressive set value for the derived elastomer. The fluoroelastomer precursor gum has a Mooney viscosity of from about 0 to about 150 ML₁₊₁₀ at 121 degrees Celsius.

A gum-enhanced polymeric admixture in a continuous polymeric phase in an electrically conductive fluoropolymeric material embodiment for a fuel hose embodiment alternatively is an interpenetrated structure of polymer from the above fundamental polymer set admixed with elastomer precursor gum, a continuous phase of polymer from the above fundamental polymer set admixed with a dispersed phase of elastomer precursor gum, or a dispersed phase of polymer from the above fundamental polymer set admixed into a continuous phase of elastomer precursor gum.

In the above embodiments fluoroelastomer (either as a material or material of reference in either the fundamental polymer set or an elastomer ultimately derived from an elastomer precursor gum) is any of

(a) vinylidene fluoride/hexafluoropropylene copolymer fluoroelastomer having from about 66 weight percent to about 69 weight percent fluorine and a Mooney viscosity of from about 0 to about 130 ML₁₊₁₀ at 121 degrees Celsius,

(b) vinylidene fluoride/perfluorovinyl ether/tetrafluoroethylene terpolymer fluoroelastomer having at least one cure site monomer and from about 64 weight percent to about 67 weight percent fluorine and a Mooney viscosity of from about 50 to about 100 ML₁₊₁₀ at 121 degrees Celsius,

(c) tetrafluoroethylene/propylene/vinylidene fluoride terpolymer fluoroelastomer having from about 59 weight percent to about 63 weight percent fluorine and a Mooney viscosity of from about 25 to about 45 ML₁₊₁₀ at 121 degrees Celsius,

(d) tetrafluoroethylene/ethylene/perfluorovinyl ether terpolymer fluoroelastomer having at least one cure site monomer and from about 60 weight percent to about 65 weight percent fluorine and a Mooney viscosity of from about 40 to about 80 ML₁₊₁₀ at 121 degrees Celsius,

(e) vinylidene fluoride/hexafluoropropylene/tetrafluoroethylene terpolymer fluoroelastomer having at least one cure site monomer and from about 66 weight percent to about 72.5 weight percent fluorine and a Mooney viscosity of from about 15 to about 90 ML₁₊₁₀ at 121 degrees Celsius,

(f) tetrafluoroethylene/propylene copolymer fluoroelastomer having about 57 weight percent fluorine and a Mooney viscosity of from about 25 to about 115 ML₁₊₁₀ at 121 degrees Celsius,

(g) tetrafluoroethylene/ethylene/perfluorovinyl ether/vinylidene fluoride tetrapolymer fluoroelastomer having at least one cure site monomer and from about 59 weight percent to about 64 weight percent fluorine and a Mooney viscosity of from about 30 to about 70 ML₁₊₁₀ at 121 degrees Celsius,

(h) tetrafluoroethylene/perfluorovinyl ether copolymer fluoroelastomer having at least one cure site monomer and from about 69 weight percent to about 71 weight percent fluorine and a Mooney viscosity of from about 60 to about 120 ML₁₊₁₀ at 121 degrees Celsius, fluoroelastomer corresponding to the formula
[—TFE_{q}—HFPᵣ—VdFₛ—]_{d}

and

(i) combinations thereof,

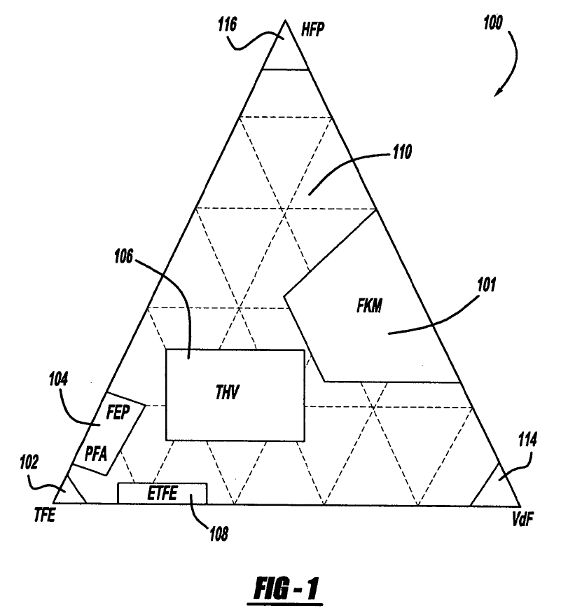

(j) where TFE is essentially a tetrafluoroethyl block, HFP is essentially a hexfluoropropyl block, and VdF is essentially a vinylidyl fluoride block, and products qd and rd and sd collectively provide proportions of TFE, HFP, and VdF whose values are within element 101 of FIG. 1 as described in the following paragraph.

Turning now to FIG. 1, a ternary composition diagram 100 is presented showing tetrafluoroethylene (TFE), hexfluoropropylene (HFP), and vinylidene fluoride weight percentage combinations for making various co-polymer blends. Region 101 defines blends of respective tetrafluoroethyl, hexfluoropropyl, and vinylidyl fluoride overall block amounts that combine to form fluoroelastomer (FKM) polymers. Region 104 defines blends of respective tetrafluoroethyl, hexfluoropropyl, and vinylidyl fluoride overall block amounts that combine to form perfluoroalkoxy tetrafluoroethylene/perfluoromethylvinyl ether and tetrafluoroethylene/hexafluoropropylene polymers. Region 106 defines blends of respective tetrafluoroethyl, hexfluoropropyl, and vinylidyl fluoride overall block amounts that combine to form tetrafluoroethylene/hexafluoropropylene/vinylidene fluoride polymers. Region 108 defines blends of respective tetrafluoroethyl, hexfluoropropyl, and vinylidyl fluoride overall block amounts that combine to form ethylene tetrafluoroethylene polymers. Region 110 defines blends of respective tetrafluoroethyl, hexfluoropropyl, and vinylidyl fluoride overall block amounts that traditionally have not generated useful co-polymers. Region 102 defines blends of respective tetrafluoroethyl, hexfluoropropyl, and vinylidyl fluoride overall block amounts that combine to form polytetrafluoroethylene (PTFE) polymers. Region 114 defines blends of respective tetrafluoroethyl, hexfluoropropyl, and vinylidyl fluoride overall block amounts that combine to form polyvinylidene fluoride (PVdF) polymers. Region 116 defines blends of respective tetrafluoroethyl, hexfluoropropyl, and vinylidyl fluoride overall block amounts that combine to form polyhexfluoropropylene (PHFP) polymers.

Thermoplastic polymer in TPE and TPV material embodiments for a fuel hose embodiment includes any of polyamide, nylon 6, nylon 66, nylon 64, nylon 63, nylon 610, nylon 612, amorphous nylon, polyester, polyethylene terephthalate, polystyrene, polymethyl methacrylate, thermoplastic polyurethane, polybutylene, polyesteretherketone, polyimide, fluoroplastic, polyvinylidene fluoride, polysulfone, polycarbonate, polyphenylene sulfide, polyethylene, polypropylene, polyacetal polymer, polyacetal, perfluoroalkoxy (tetrafluoroethylene/perfluoromethylvinyl ether), tetrafluoroethylene/perfluoromethylvinyl ether, ethylene tetrafluoroethylene, ethylene chlorotrifluoroethylene, tetrafluoroethylene/hexafluoropropylene/vinylidene fluoride, tetrafluoroethylene/hexafluoropropylene, polyester thermoplastic ester, polyester ether copolymer, polyamide ether copolymer, polyamide thermoplastic ester, and combinations thereof.

Another form of modification to the traditional three general primary categories of thermoset plastic materials, thermoplastic plastic materials, and elastomeric materials is cross-linked thermoplastic material, where a thermoplastic undergoes a certain degree of cross-linking via a treatment such as irradiation after having been solidified (to contain crystals of the thermoplastic polymer). In this regard, while the melting point of crystals in a cross-linked thermoplastic is sustained in all crystalline portions of the thermoplastic, the dynamic modulus of the cross-linked thermoplastic will be higher than that of the non-crosslinked thermoplastic due to crosslinkage between thermoplastic molecules in the amorphous phase of the thermoplastic. Further details in this regard are described in U.S. patent application Ser. No. 10/881,106 filed on Jun. 30, 2004 and entitled ELECTRON BEAM INTER-CURING OF PLASTIC AND ELASTOMER BLENDS incorporated by reference herein. In one such embodiment, the plastic moiety is derived from thermoplastic plastic; in a second embodiment, the plastic is derived from thermoset plastic.

Electron beam processing is usually effected with an electron accelerator. Individual accelerators are usefully characterized by their energy, power, and type. Low-energy accelerators provide beam energies from about 150 keV to about 2.0 MeV. Medium-energy accelerators provide beam energies from about 2.5 to about 8.0 MeV. High-energy accelerators provide beam energies greater than about 9.0 MeV. Accelerator power is a product of electron energy and beam current. Such powers range from about 5 to about 300 kW. The main types of accelerators are: electrostatic direct-current (DC), electrodynamic DC, radiofrequency (RF) linear accelerators (LINACS), magnetic-induction LINACs, and continuous-wave (CW) machines.

A polymeric admixture established by admixing differentiated phases of polymer usually differentiates the continuous phase and dispersed phase on the basis of relative viscosity between two initial polymeric fluids (where the first polymeric fluid has a first viscosity and the second polymeric fluid has a second viscosity). The phases are differentiated during admixing of the admixture from the two initial polymeric fluids. In this regard, the phase having the lower viscosity of the two phases will generally encapsulate the phase having the higher viscosity. The lower viscosity phase will therefore usually become the continuous phase in the admixture, and the higher viscosity phase will become the dispersed phase. When the viscosities are essentially equal, the two phases will form an interpenetrated structure of polymer chains. Accordingly, in general dependence upon the relative viscosities of the admixed elastomer and thermoplastic, several embodiments of admixed compositions derive from the general admixing approach and irradiation.

Preferably, each of the vulcanized, partially vulcanized, or gum elastomeric dispersed portions in a polymeric admixture has a cross-sectional diameter from about 0.1 microns to about 100 microns. In this regard, it is to be further appreciated that any portion is essentially spherical in shape in one embodiment, or, in an alternative embodiment, is filamentary in shape with the filament having a cross-sectional diameter from about 0.1 microns to about 100 microns. Comparably, when the vulcanized, partially vulcanized, or gum elastomeric portion is the continuous portion, the dispersed polymeric portion also has a cross-sectional diameter from about 0.1 microns to about 100 microns. The continuous phase of the polymeric admixture collectively is from about 20 weight percent to about 90 weight percent of the polymeric admixture composition.

In one embodiment, filler (particulate material contributing to the performance properties of the compounded electrically conductive polymeric material respective to such properties as, without limitation, bulk, weight, and/or viscosity while being essentially chemically inert or essentially reactively insignificant respective to chemical reactions within the compounded polymer) is also admixed into the formulation. The filler particulate is any material such as, without limitation, fiberglass particulate, inorganic fiber particulate, carbon fiber particulate, ground rubber particulate, or polytetrafluorinated ethylene particulate having a mean particle size from about 5 to about 50 microns; fiberglass, ceramic, or glass microspheres preferably having a mean particle size from about 5 to about 120 microns; or carbon nanotubes.

Turning now to method embodiments for making material embodiments discussed in the foregoing, one method embodiment for making a material compound embodiment is to admix the components of the continuous polymer phase with a conventional mixing system such as a batch polymer mixer, a roll mill, a continuous mixer, a single-screw mixing extruder, a twin-screw extruder mixing extruder, and the like until the continuous polymeric phase has been fully admixed. Specific commercial batch polymer mixer systems in this regard include any of a Moriyama mixer, a Banbury mixer, and a Brabender mixer. In another embodiment the elastomeric and thermoplastic components are intermixed at elevated temperature in the presence of an additive package in conventional mixing equipment as noted above. The conductive particulate and optional filler is then admixed into the continuous polymeric phase until fully dispersed in the continuous polymeric phase to yield the electrically conductive polymeric material. In one method embodiment, the components of the continuous polymer phase and the conductive (and optional filler) particulate are simultaneously admixed with a conventional mixing system such as a roll mill, continuous mixer, a single-screw mixing extruder, a twin-screw extruder mixing extruder, and the like until the conductive material has been fully admixed. In one embodiment, a curing agent (a fluoroelastomer curing agent such as preferably, without limitation, a peroxide, a bisphenol, and a combination of these) is admixed into the elastomer precursor solution shortly before use, and the electrically conductive fluoropolymeric material is then co-extruded into a fuel hose. In another embodiment, the electrically conductive fluoropolymeric material is molded into a fuel hose precursor and the molded precursor fuel hose is cured with radiation to yield the desired fuel hose.

A further advantageous characteristic of fully admixed compositions is that the admixture is readily processed and/or reprocessed by conventional plastic processing techniques such as extrusion, injection molding, and compression molding. Scrap or flashing is also readily salvaged and reprocessed with thermoplastic processing techniques.

In a preferred embodiment, a coating is applied to the conductive particles (and optionally to the optional filler), prior to the admixing, with a coating to provide coated conductive particles (and optionally coated filler) as the conductive particulate (and optional filler). In this regard, given that the uncoated particles have a (first) surface tension between the uncoated particles and the fluoropolymer, the coating is chosen so that the coated particles have a (second) surface tension between the coated particles and the fluoropolymer that is less than the first surface tension. The coating is applied to enable expedited admixing of the particulate into a full dispersion within the continuous polymer phase. The coating is selected and the coated conductive particles are dispersed in sufficient quantity so that the desired electrical resistivity is achieved in the polymeric fuel hose.

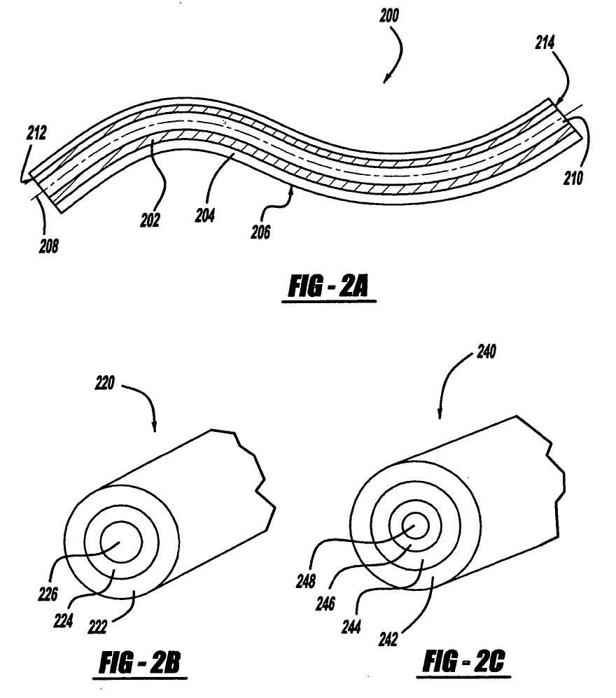

Turning now to detail in a fuel hose embodiment, FIG. 2A shows cross-sectional elongated detail 200 in fuel hose 206. Fuel hose 206 provides a multilayer fuel line. Fuel flows within flow channel 210 (flow channel 210 being encircled and defined by the inner surface of inner layer 202) from inlet end 212 to outlet end 214. Flow axis 208 is shown as a serpentine centerline between inlet end 212 to outlet end 214 in detail 200. Fluoropolymer inner layer 202 extends along flow axis 208 from inlet end 212 to outlet end 214 of hose 206. Fluoropolymer inner layer 202 is cured from electrically conductive fluoropolymeric material as previously described and has electrical resistivity of less than about of 1×10 ⁻³ Ohm-m at 20 degrees Celsius. Polymeric outer structural layer 204 adheres to the outside surface of inner layer 202. Polymeric outer structural layer 204 is made of any polymer of acrylic acid ester rubber/polyacrylate rubber thermoplastic vulcanizate acrylonitrile-butadiene-styrene, amorphous nylon, cellulosic plastic, ethylene chlorotrifluoroethylene, epoxy resin, ethylene tetrafluoroethylene, ethylene acrylic rubber, ethylene acrylic rubber thermoplastic vulcanizate, ethylene acrylic monomer rubber/polyester thermoplastic elastomer, ethylene-propylene-diamine monomer rubber/polypropylene thermoplastic vulcanizate, tetrafluoroethylene/hexafluoropropylene, fluoroelastomer, fluoroelastomer thermoplastic vulcanizate, fluoroplastic, hydrogenated nitrile rubber, melamine-formaldehyde resin, tetrafluoroethylene/perfluoromethylvinyl ether, natural rubber, ethylene vinyl acetate, nitrile butyl rubber, nylon, nylon 6, nylon 610, nylon 612, nylon 63, nylon 64, nylon 66, perfluoroalkoxy (tetrafluoroethylene/perfluoromethylvinyl ether), phenolic resin, polyacetal, polyacrylate, polyamide, polyamide thermoset plastic, polyamide-imide, polybutene, polybutylene, polycarbonate, polyester, polyester thermoplastic, thermoplastic elastomer, polyesteretherketone, polyethylene, polyethylene terephthalate, polybutylene terephthalate, polyimide, polymethylmethacrylate, polyolefin, polyphenylene sulfide, polypropylene, polystyrene, polysulfone, polytetrafluoroethylene, polyurethane, polyurethane elastomer, polyvinyl chloride, polyvinylidene fluoride, ethylene propylene dimethyl/polypropylene thermoplastic vulcanizate, silicone, silicone-thermoplastic vulcanizate, silicone/polyacrylate, silicone/polyethylene terephthalate, thermoplastic polyurethane, thermoplastic polyurethane elastomer, thermoplastic polyurethane vulcanizate, polyurethane/polyamide thermoplastic elastomer, thermoplastic silicone vulcanizate, thermoplastic urethane, thermoplastic urethane elastomer, tetrafluoroethylene/hexafluoropropylene/vinylidene fluoride, polyamide-imide, and combinations thereof.

In one embodiment outer layer 204 adheres to inner layer 202 through use of an adhesive, such as polyethylene vinyl acetate. In an alternative embodiment, outer layer 204 adheres to inner layer 202 through use of an interface as described in U.S. patent application Ser. No. 10/881,677 filed on Jun. 30, 2004 and entitled ELECTRON BEAM CURING IN A COMPOSITE HAVING A FLOW RESISTANT ADHESIVE LAYER incorporated by reference herein. In yet another embodiment, outer layer 204 adheres to inner layer 202 through use of electron beam generated chimerical polymeric molecules as described in U.S. patent application Ser. No. 10/881,677.

One embodiment of a multi-layer fuel line with an electrically conductive fluoropolymeric inner layer is shown in FIG. 2B as cross-sectional view 220 of a two layer fuel hose essentially similar to hose 214 of view 200. In the two layer hose of view 220, no adhesive layer is provided between outer layer 222 and inner layer 224; outer layer 222 and inner layer 204 are fluoropolymeric layers adjoined after electron beam treatment as described in U.S. patent application Ser. No. 10/881,677. Flow channel 226 (encircled and defined by the inner surface of inner layer 224) carries fuel flow.

FIG. 2C shows cross-sectional view 240 of a three layer fuel hose embodiment having, in one embodiment, a fluoropolymer inner layer 246 surrounding flow channel 248 and an adhesive layer 244 bonded to both fluoropolymer inner layer 246 and to structural layer 242. In an alternative embodiment according to cross-sectional view 240, fluoropolymer inner layer 246 is a fluoroelastomer, layer 244 is a fluorinated thermoplastic, and structural layer 242 is a thermoplastic vulcanizate.

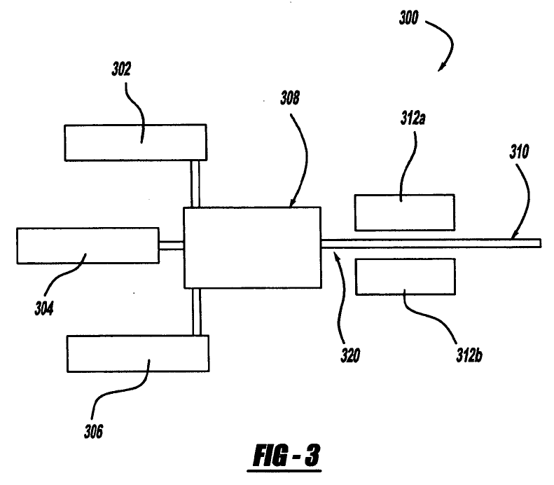

FIG. 3 shows a co-extrusion process 300 for making multilayer fuel hose 310. In this regard, fuel hose 310 has a cross-sectional profile according to view 240. Extruder 302 provides polymer for fluoropolymer inner layer 246; extruder 304 provides polymer for layer 248, and extruder 306 provides polymer for layer 242. The polymers from extruders 302, 304 and 306 are combined in die 308 to form multi-layer precursor fuel line 320 which is then cured (cross-linked) by electron beam system 312 (shown in cutaway as top electron beam system portion 312a and bottom electron beam system portion 312b) into fuel hose 310 (fuel line 310).

In a preferred embodiment, the irradiative curing by electron beam system 312 is achieved by irradiating fuel hose precursor 320 with electron beam radiation (preferably of from about 0.1 MeRAD to about 40 MeRAD and, more preferably, from about 5 MeRAD to about 20 MeRAD).

The radiation used for curing is, in alternative method embodiments, ultraviolet radiation, infrared radiation, ionizing radiation, electron beam radiation, x-ray radiation, an irradiating plasma, a discharging corona, or a combination of these.

The examples and other embodiments described herein are exemplary and not intended to be limiting in describing the full scope of compositions and methods of this invention. Equivalent changes, modifications and variations of specific embodiments, materials, compositions and methods may be made within the scope of the present invention, with substantially similar results.

What is claimed is:

1. A multilayer fuel line having an inlet end, an outlet end, and a flow axis between said inlet end and said outlet end, said fuel line comprising:
(a) a fluoropolymer inner layer extending along said flow axis from said inlet end to said outlet end, said inner layer having electrical resistivity of less than about of 1×10⁻³ Ohm-m at 20 degrees Celsius, said inner layer having an outside surface; and
(b) a polymeric outer structural layer adhered to said outside surface of said inner layer.

2. The fuel line of claim 1 wherein said fluoropolymer inner layer comprises:
(i) a continuous polymeric phase; and
(ii) a dispersed phase of conductive particulate, said dispersed phase comprising a plurality of conductive particles dispersed in said continuous polymeric phase.

3. The fuel line of claim 1 wherein said fluoropolymer inner layer comprises polymer selected from the group consisting of fluoroelastomer vulcanized to provide a compressive set value from about 5 to about 100 percent of a mathematical difference between a non-vulcanized compressive set value for said fluoroelastomer and a fully-vulcanized compressive set value for said fluoroelastomer, fluoroelastomer thermoplastic vulcanizate vulcanized to provide a compressive set value from about 5 to about 100 percent of a mathematical difference between a non-vulcanized compressive set value for said fluoroelastomer of said fluoroelastomer thermoplastic vulcanizate and a fully-vulcanized compressive set value for said fluoroelastomer of said fluoroelastomer thermoplastic vulcanizate, fluoroelastomer-based thermoplastic elastomer vulcanized to provide a compressive set value from about 5 to about 100 percent of a mathematical difference between a non-vulcanized compressive set value for said thermoplastic elastomer and a fully-vulcanized compressive set value for said thermoplastic elastomer, and a blend of fluoroelastomer precursor gum and thermoplastic wherein said precursor gum has a glass transition temperature, a decomposition temperature, a Mooney viscosity of from about 0 to about 150 ML₁₊₁₀ at 121 degrees Celsius, and, at a temperature having a value that is not less than said glass transition temperature and not greater than said decomposition temperature, a compressive set value from about 0 to about 5 percent of a mathematical difference between a non-vulcanized compressive set value for fluoroelastomer derived from said fluoroelastomer precursor gum and a fully-vulcanized compressive set value for said derived fluoroelastomer.

4. The fuel line of claim 3 wherein said fluoroelastomer is selected from the group consisting of
(i) vinylidene fluoride/hexafluoropropylene copolymer fluoroelastomer having from about 66 weight percent to about 69 weight percent fluorine and a Mooney viscosity of from about 0 to about 130 ML₁₊₁₀ at 121 degrees Celsius,
(ii) vinylidene fluoride/perfluorovinyl ether/tetrafluoroethylene terpolymer fluoroelastomer having at least one cure site monomer and from about 64 weight percent to about 67 weight percent fluorine and a Mooney viscosity of from about 50 to about 100 ML₁₊₁₀ at 121 degrees Celsius,
(iii) tetrafluoroethylene/propylene/vinylidene fluoride terpolymer fluoroelastomer having from about 59 weight percent to about 63 weight percent fluorine and a Mooney viscosity of from about 25 to about 45 ML₁₊₁₀ at 121 degrees Celsius,
(iv) tetrafluoroethylene/ethylene/perfluorovinyl ether terpolymer fluoroelastomer having at least one cure site monomer and from about 60 weight percent to about 65 weight percent fluorine and a Mooney viscosity of from about 40 to about 80 ML₁₊₁₀ at 121 degrees Celsius,
(v) vinylidene fluoride/hexafluoropropylene/tetrafluoroethylene terpolymer fluoroelastomer having at least one cure site monomer and from about 66 weight percent to about 72.5 weight percent fluorine and a Mooney viscosity of from about 15 to about 90 ML₁₊₁₀ at 121 degrees Celsius,
(vi) tetrafluoroethylene/propylene copolymer fluoroelastomer having about 57 weight percent fluorine and a Mooney viscosity of from about 25 to about 115 ML₁₊₁₀ at 121 degrees Celsius,
(vii) tetrafluoroethylene/ethylene/perfluorovinyl ether/vinylidene fluoride tetrapolymer fluoroelastomer having at least one cure site monomer and from about 59 weight percent to about 64 weight percent fluorine and a Mooney viscosity of from about 30 to about 70 ML₁₊₁₀ at 121 degrees Celsius,
(viii) tetrafluoroethylene/perfluorovinyl ether copolymer fluoroelastomer having at least one cure site monomer and from about 69 weight percent to about 71 weight percent fluorine and a Mooney viscosity of from about 60 to about 120 ML₁₊₁₀ at 121 degrees Celsius, fluoroelastomer corresponding to the formula
[—TFE_{q}—HFPᵣ—VdFₛ—]d
and
(ix) combinations thereof,
(x) wherein TFE is essentially a tetrafluoroethyl block, HFP is essentially a hexfluoropropyl block, and VdF is essentially a vinylidyl fluoride block, and products qd and rd and sd collectively provide proportions of TFE, HFP, and VdF whose values are within element 101 of FIG. 1.

5. The fuel line of claim 1 wherein said fluoropolymer inner layer is cured from fluoropolymer precursor selected from the group consisting of fluoroelastomer, fluoroelastomer thermoplastic vulcanizate, fluoroelastomer thermoplastic elastomer vulcanized to provide a compressive set value from about 5 to about 100 percent of a mathematical difference between a non-vulcanized compressive set value for said fluoroelastomer thermoplastic elastomer and a fully-vulcanized compressive set value for said fluoroelastomer thermoplastic elastomer, and a blend of fluoroelastomer precursor gum and thermoplastic wherein said precursor gum has a glass transition temperature, a decomposition temperature, a Mooney viscosity of from about 0 to about 150 ML₁₊₁₀ at 121 degrees Celsius, and, at a temperature having a value that is not less than said glass transition temperature and not greater than said decomposition temperature, a compressive set value from about 0 to about 5 percent of a mathematical difference between a non-vulcanized compressive set value for fluoroelastomer derived from said fluoroelastomer precursor gum and a fully-vulcanized compressive set value for said derived fluoroelastomer.

6. The fuel line of claim 5 wherein said fluoroelastomer is selected from the group consisting of
(i) vinylidene fluoride/hexafluoropropylene copolymer fluoroelastomer having from about 66 weight percent to about 69 weight percent fluorine and a Mooney viscosity of from about 0 to about 130 ML₁₊₁₀ at 121 degrees Celsius,
(ii) vinylidene fluoride/perfluorovinyl ether/tetrafluoroethylene terpolymer fluoroelastomer having at least one cure site monomer and from about 64 weight percent to about 67 weight percent fluorine and a Mooney viscosity of from about 50 to about 100 ML₁₊₁₀ at 121 degrees Celsius,
(iii) tetrafluoroethylene/propylene/vinylidene fluoride terpolymer fluoroelastomer having from about 59 weight percent to about 63 weight percent fluorine and a Mooney viscosity of from about 25 to about 45 ML₁₊₁₀ at 121 degrees Celsius,
(iv) tetrafluoroethylene/ethylene/perfluorovinyl ether terpolymer fluoroelastomer having at least one cure site monomer and from about 60 weight percent to about 65 weight percent fluorine and a Mooney viscosity of from about 40 to about 80 ML₁₊₁₀ at 121 degrees Celsius,
(v) vinylidene fluoride/hexafluoropropylene/tetrafluoroethylene terpolymer fluoroelastomer having at least one cure site monomer and from about 66 weight percent to about 72.5 weight percent fluorine and a Mooney viscosity of from about 15 to about 90 ML₁₊₁₀ at 121 degrees Celsius,
(vi) tetrafluoroethylene/propylene copolymer fluoroelastomer having about 57 weight percent fluorine and a Mooney viscosity of from about 25 to about 115 ML₁₊₁₀ at 121 degrees Celsius,
(vii) tetrafluoroethylene/ethylene/perfluorovinyl ether/vinylidene fluoride tetrapolymer fluoroelastomer having at least one cure site monomer and from about 59 weight percent to about 64 weight percent fluorine and a Mooney viscosity of from about 30 to about 70 ML₁₊₁₀ at 121 degrees Celsius,
(viii) tetrafluoroethylene/perfluorovinyl ether copolymer fluoroelastomer having at least one cure site monomer and from about 69 weight percent to about 71 weight percent fluorine and a Mooney viscosity of from about 60 to about 120 ML₁₊₁₀ at 121 degrees Celsius, fluoroelastomer corresponding to the formula
[—TFE_{q}—HFPᵣ—VdFₛ—]d
and
(ix) combinations thereof,
(x) wherein TFE is essentially a tetrafluoroethyl block, HFP is essentially a hexfluoropropyl block, and VdF is essentially a vinylidyl fluoride block, and products qd and rd and sd collectively provide proportions of TFE, HFP, and VdF whose values are within element 101 of FIG. 1.

7. The fuel line of claim 1 wherein said fluoropolymer inner layer is derived from radiation curing of a fluoropolymer precursor.

8. The fuel line of claim 7 wherein said radiation is selected from the group consisting of ultraviolet radiation, infrared radiation, ionizing radiation, electron beam radiation, x-ray radiation, an irradiating plasma, a discharging corona, and a combination of these.

9. The fuel line of claim 1 wherein said fluoropolymer inner layer is derived from curing fluoroelastomer with a curing agent selected from the group consisting of a peroxide, a bisphenol, and a combination of these.

10. The fuel line of claim 2 wherein said conductive particulate is selected from the group consisting of conductive carbon black, conductive carbon fiber, conductive carbon nanotubes, conductive graphite powder, conductive graphite fiber, bronze powder, bronze fiber, steel powder, steel fiber, iron powder, iron fiber, copper powder, copper fiber, silver powder, silver fiber, aluminum powder, aluminum fiber, nickel powder, nickel fiber, wolfram powder, wolfram fiber, gold powder, gold fiber, copper-manganese alloy powder, copper-manganese fiber, and combinations thereof.

11. The fuel line of claim 2 wherein said fluoropolymer inner layer comprises polymer selected from the group consisting of fluoroelastomer vulcanized to provide a compressive set value from about 5 to about 100 percent of a mathematical difference between a non-vulcanized compressive set value for said fluoroelastomer and a fully-vulcanized compressive set value for said fluoroelastomer, fluoroelastomer thermoplastic vulcanizate vulcanized to provide a compressive set value from about 5 to about 100 percent of a mathematical difference between a non-vulcanized compressive set value for said fluoroelastomer of said fluoroelastomer thermoplastic vulcanizate and a fully-vulcanized compressive set value for said fluoroelastomer of said fluoroelastomer thermoplastic vulcanizate, fluoroelastomer-based thermoplastic elastomer vulcanized to provide a compressive set value from about 5 to about 100 percent of a mathematical difference between a non-vulcanized compressive set value for said thermoplastic elastomer and a fully-vulcanized compressive set value for said thermoplastic elastomer, and a blend of fluoroelastomer precursor gum and thermoplastic wherein said precursor gum has a glass transition temperature, a decomposition temperature, a Mooney viscosity of from about 0 to about 150 ML₁₊₁₀ at 121 degrees Celsius, and, at a temperature having a value that is not less than said glass transition temperature and not greater than said decomposition temperature, a compressive set value from about 0 to about 5 percent of a mathematical difference between a non-vulcanized compressive set value for fluoroelastomer derived from said fluoroelastomer precursor gum and a fully-vulcanized compressive set value for said derived fluoroelastomer; and
said conductive particulate is selected from the group consisting of conductive carbon black, conductive carbon fiber, conductive carbon nanotubes, conductive graphite powder, conductive graphite fiber, bronze powder, bronze fiber, steel powder, steel fiber, iron powder, iron fiber, copper powder, copper fiber, silver powder, silver fiber, aluminum powder, aluminum fiber, nickel powder, nickel fiber, wolfram powder, wolfram fiber, gold powder, gold fiber, copper-manganese alloy powder, copper-manganese fiber, and combinations thereof.

12. The fuel line of claim 11 wherein said fluoroelastomer is selected from the group consisting of
(i) vinylidene fluoride/hexafluoropropylene copolymer fluoroelastomer having from about 66 weight percent to about 69 weight percent fluorine and a Mooney viscosity of from about 0 to about 130 ML₁₊₁₀ at 121 degrees Celsius,
(ii) vinylidene fluoride/perfluorovinyl ether/tetrafluoroethylene terpolymer fluoroelastomer having at least one cure site monomer and from about 64 weight percent to about 67 weight percent fluorine and a Mooney viscosity of from about 50 to about 100 ML₁₊₁₀ at 121 degrees Celsius,
(iii) tetrafluoroethylene/propylene/vinylidene fluoride terpolymer fluoroelastomer having from about 59 weight percent to about 63 weight percent fluorine and a Mooney viscosity of from about 25 to about 45 ML₁₊₁₀ at 121 degrees Celsius,
(iv) tetrafluoroethylene/ethylene/perfluorovinyl ether terpolymer fluoroelastomer having at least one cure site monomer and from about 60 weight percent to about 65 weight percent fluorine and a Mooney viscosity of from about 40 to about 80 ML₁₊₁₀ at 121 degrees Celsius,
(v) vinylidene fluoride/hexafluoropropylene/tetrafluoroethylene terpolymer fluoroelastomer having at least one cure site monomer and from about 66 weight percent to about 72.5 weight percent fluorine and a Mooney viscosity of from about 15 to about 90 ML₁₊₁₀ at 121 degrees Celsius,
(vi) tetrafluoroethylene/propylene copolymer fluoroelastomer having about 57 weight percent fluorine and a Mooney viscosity of from about 25 to about 115 ML₁₊₁₀ at 121 degrees Celsius,
(vii) tetrafluoroethylene/ethylene/perfluorovinyl ether/vinylidene fluoride tetrapolymer fluoroelastomer having at least one cure site monomer and from about 59 weight percent to about 64 weight percent fluorine and a Mooney viscosity of from about 30 to about 70 ML₁₊₁₀ at 121 degrees Celsius,
(viii) tetrafluoroethylene/perfluorovinyl ether copolymer fluoroelastomer having at least one cure site monomer and from about 69 weight percent to about 71 weight percent fluorine and a Mooney viscosity of from about 60 to about 120 ML₁₊₁₀ at 121 degrees Celsius, fluoroelastomer corresponding to the formula
[—TFE_{q}—HFPᵣ—VdFₛ—]d
and
(ix) combinations thereof,
(x) wherein TFE is essentially a tetrafluoroethyl block, HFP is essentially a hexfluoropropyl block, and VdF is essentially a vinylidyl fluoride block, and products qd and rd and sd collectively provide proportions of TFE, HFP, and VdF whose values are within element 101 of FIG. 1.

13. The fuel line of claim 2 wherein said fluoropolymer inner layer is cured from fluoropolymer precursor selected from the group consisting of fluoroelastomer vulcanized to provide a compressive set value from about 5 to about 100 percent of a mathematical difference between a non-vulcanized compressive set value for said fluoroelastomer and a fully-vulcanized compressive set value for said fluoroelastomer, fluoroelastomer thermoplastic vulcanizate vulcanized to provide a compressive set value from about 5 to about 100 percent of a mathematical difference between a non-vulcanized compressive set value for said fluoroelastomer of said fluoroelastomer thermoplastic vulcanizate and a fully-vulcanized compressive set value for said fluoroelastomer of said fluoroelastomer thermoplastic vulcanizate, fluoroelastomer-based thermoplastic elastomer vulcanized to provide a compressive set value from about 5 to about 100 percent of a mathematical difference between a non-vulcanized compressive set value for said thermoplastic elastomer and a fully-vulcanized compressive set value for said thermoplastic elastomer, and a blend of fluoroelastomer precursor gum and thermoplastic wherein said precursor gum has a glass transition temperature, a decomposition temperature, a Mooney viscosity of from about 0 to about 150 ML₁₊₁₀ at 121 degrees Celsius, and, at a temperature having a value that is not less than said glass transition temperature and not greater than said decomposition temperature, a compressive set value from about 0 to about 5 percent of a mathematical difference between a non-vulcanized compressive set value for fluoroelastomer derived from said fluoroelastomer precursor gum and a fully-vulcanized compressive set value for said derived fluoroelastomer; and
said conductive particulate is selected from the group consisting of conductive carbon black, conductive carbon fiber, conductive carbon nanotubes, conductive graphite powder, conductive graphite fiber, bronze powder, bronze fiber, steel powder, steel fiber, iron powder, iron fiber, copper powder, copper fiber, silver powder, silver fiber, aluminum powder, aluminum fiber, nickel powder, nickel fiber, wolfram powder, wolfram fiber, gold powder, gold fiber, copper-manganese alloy powder, copper-manganese fiber, and combinations thereof.

14. The fuel line of claim 13 wherein said fluoroelastomer is selected from the group consisting of
(i) vinylidene fluoride/hexafluoropropylene copolymer fluoroelastomer having from about 66 weight percent to about 69 weight percent fluorine and a Mooney viscosity of from about 0 to about 130 ML₁₊₁₀ at 121 degrees Celsius,
(ii) vinylidene fluoride/perfluorovinyl ether/tetrafluoroethylene terpolymer fluoroelastomer having at least one cure site monomer and from about 64 weight percent to about 67 weight percent fluorine and a Mooney viscosity of from about 50 to about 100 ML₁₊₁₀ at 121 degrees Celsius,
(iii) tetrafluoroethylene/propylene/vinylidene fluoride terpolymer fluoroelastomer having from about 59 weight percent to about 63 weight percent fluorine and a Mooney viscosity of from about 25 to about 45 ML₁₊₁₀ at 121 degrees Celsius,
(iv) tetrafluoroethylene/ethylene/perfluorovinyl ether terpolymer fluoroelastomer having at least one cure site monomer and from about 60 weight percent to about 65 weight percent fluorine and a Mooney viscosity of from about 40 to about 80 ML₁₊₁₀ at 121 degrees Celsius,
(v) vinylidene fluoride/hexafluoropropylene/tetrafluoroethylene terpolymer fluoroelastomer having at least one cure site monomer and from about 66 weight percent to about 72.5 weight percent fluorine and a Mooney viscosity of from about 15 to about 90 ML₁₊₁₀ at 121 degrees Celsius,
(vi) tetrafluoroethylene/propylene copolymer fluoroelastomer having about 57 weight percent fluorine and a Mooney viscosity of from about 25 to about 115 ML₁₊₁₀ at 121 degrees Celsius,
(vii) tetrafluoroethylene/ethylene/perfluorovinyl ether/vinylidene fluoride tetrapolymer fluoroelastomer having at least one cure site monomer and from about 59 weight percent to about 64 weight percent fluorine and a Mooney viscosity of from about 30 to about 70 ML₁₊₁₀ at 121 degrees Celsius,
(viii) tetrafluoroethylene/perfluorovinyl ether copolymer fluoroelastomer having at least one cure site monomer and from about 69 weight percent to about 71 weight percent fluorine and a Mooney viscosity of from about 60 to about 120 ML₁₊₁₀ at 121 degrees Celsius, fluoroelastomer corresponding to the formula
[—TFE_{q}—HFPᵣ—VdFₛ—]d
and
(ix) combinations thereof,
(x) wherein TFE is essentially a tetrafluoroethyl block, HFP is essentially a hexfluoropropyl block, and VdF is essentially a vinylidyl fluoride block, and products qd and rd and sd collectively provide proportions of TFE, HFP, and VdF whose values are within element 101 of FIG. 1.

15. The fuel line of claim 1 wherein said polymeric outer structural layer comprises structural polymer selected from the group consisting of acrylic acid ester rubber/polyacrylate rubber thermoplastic vulcanizate acrylonitrile-butadiene-styrene, amorphous nylon, cellulosic plastic, ethylene chlorotrifluoroethylene, epoxy resin, ethylene tetrafluoroethylene, ethylene acrylic rubber, ethylene acrylic rubber thermoplastic vulcanizate, ethylene-propylene-diamine monomer rubber/polypropylene thermoplastic vulcanizate, tetrafluoroethylene/hexafluoropropylene, fluoroelastomer, fluoroelastomer thermoplastic vulcanizate, fluoroplastic, hydrogenated nitrile rubber, melamine-formaldehyde resin, tetrafluoroethylene/perfluoromethylvinyl ether, natural rubber, nitrile butyl rubber, nylon, nylon 6, nylon 610, nylon 612, nylon 63, nylon 64, nylon 66, perfluoroalkoxy (tetrafluoroethylene/perfluoromethylvinyl ether), phenolic resin, polyacetal, polyacrylate, polyamide, polyamide thermoplastic, thermoplastic elastomer, polyamide-imide, polybutene, polybutylene, polycarbonate, polyester, polyester thermoset plastic, polyesteretherketone, polyethylene, polyethylene terephthalate, polyimide, polymethylmethacrylate, polyolefin, polyphenylene sulfide, polypropylene, polystyrene, polysulfone, polytetrafluoroethylene, polyurethane, polyurethane elastomer, polyvinyl chloride, polyvinylidene fluoride, ethylene propylene dimethyl/polypropylene thermoplastic vulcanizate, silicone, silicone-thermoplastic vulcanizate, thermoplastic polyurethane, thermoplastic polyurethane elastomer, thermoplastic polyurethane vulcanizate, thermoplastic silicone vulcanizate, thermoplastic urethane, thermoplastic urethane elastomer, tetrafluoroethylene/hexafluoropropylene/vinylidene fluoride, polyamide-imide, and combinations thereof.

16. The fuel line of claim 2 wherein said conductive particles are coated with a coating to provide coated conductive particles as said conductive particulate, said conductive particles having a first surface tension between said conductive particles and said fluoropolymer, said coated conductive particles having a second surface tension between said coated conductive particles and said fluoropolymer, said second surface tension less than said first surface tension.

17. The fuel line of claim 2 wherein essentially all of said conductive particles independently have a cross-sectional diameter from about 0.1 micron to about 100 microns.

18. The fuel line of claim 2 wherein said inner layer further comprises filler selected from the group consisting of fiberglass particulate, inorganic fiber particulate, carbon fiber particulate, ground rubber particulate, polytetrafluorinated ethylene particulate, microspheres, carbon nanotubes, and combinations thereof.

19. A method for making a fuel line, said fuel line having an inlet end, an outlet end, and a flow axis between said inlet end and said outlet end, said method comprising:
(a) admixing fluoropolymer with conductive particulate to form a conductive fluoropolymer admixture;
(b) providing a structural polymer for said fuel line; and
(c) co-extruding said structural polymer and said fluoropolymer admixture into a multilayer tube having an inner layer of said fluoropolymer admixture and an outer layer of said structural polymer; wherein
(d) said admixing admixes sufficient conductive particulate such that said inner layer has, after said curing, electrical resistivity of less than about of 1×10 ⁻³ Ohm-m at 20 degrees Celsius.

20. The method of claim 19 further comprising curing said inner layer.

21. The method of claim 20 wherein said curing comprises irradiating said inner layer with radiation.

22. The method of claim 20 wherein said curing comprises admixing, prior to said co-extruding, a curing agent into said fluoropolymer admixture wherein said curing agent is selected from the group consisting of a peroxide, a bisphenol, and a combination of these.

23. The method of claim 21 wherein said radiation is selected from the group consisting of ultraviolet radiation, infrared radiation, ionizing radiation, electron beam radiation, x-ray radiation, an irradiating plasma, a discharging corona, and a combination of these.

24. The method of claim 19 wherein said admixing admixes conductive fluoropolymer admixture comprising:
(i) a continuous polymeric phase; and
(ii) a dispersed phase of said conductive particulate, said dispersed phase comprising a plurality of conductive particles dispersed in said continuous polymeric phase.

25. The method of claim 19 wherein said admixing admixes fluoropolymer selected from the group consisting of fluoroelastomer vulcanized to provide a compressive set value from about 5 to about 100 percent of a mathematical difference between a non-vulcanized compressive set value for said fluoroelastomer and a fully-vulcanized compressive set value for said fluoroelastomer, fluoroelastomer thermoplastic vulcanizate vulcanized to provide a compressive set value from about 5 to about 100 percent of a mathematical difference between a non-vulcanized compressive set value for said fluoroelastomer of said fluoroelastomer thermoplastic vulcanizate and a fully-vulcanized compressive set value for said fluoroelastomer of said fluoroelastomer thermoplastic vulcanizate, fluoroelastomer-based thermoplastic elastomer vulcanized to provide a compressive set value from about 5 to about 100 percent of a mathematical difference between a non-vulcanized compressive set value for said thermoplastic elastomer and a fully-vulcanized compressive set value for said thermoplastic elastomer, and a blend of fluoroelastomer precursor gum and thermoplastic wherein said precursor gum has a glass transition temperature, a decomposition temperature, a Mooney viscosity of from about 0 to about 150 ML₁₊₁₀ at 121 degrees Celsius, and, at a temperature having a value that is not less than said glass transition temperature and not greater than said decomposition temperature, a compressive set value from about 0 to about 5 percent of a mathematical difference between a non-vulcanized compressive set value for fluoroelastomer derived from said fluoroelastomer precursor gum and a fully-vulcanized compressive set value for said derived fluoroelastomer.

26. The method of claim 25 wherein said fluoroelastomer is selected from the group consisting of
(i) vinylidene fluoride/hexafluoropropylene copolymer fluoroelastomer having from about 66 weight percent to about 69 weight percent fluorine and a Mooney viscosity of from about 0 to about 130 ML₁₊₁₀ at 121 degrees Celsius,
(ii) vinylidene fluoride/perfluorovinyl ether/tetrafluoroethylene terpolymer fluoroelastomer having at least one cure site monomer and from about 64 weight percent to about 67 weight percent fluorine and a Mooney viscosity of from about 50 to about 100 ML₁₊₁₀ at 121 degrees Celsius,
(iii) tetrafluoroethylene/propylene/vinylidene fluoride terpolymer fluoroelastomer having from about 59 weight percent to about 63 weight percent fluorine and a Mooney viscosity of from about 25 to about 45 ML₁₊₁₀ at 121 degrees Celsius,
(iv) tetrafluoroethylene/ethylene/perfluorovinyl ether terpolymer fluoroelastomer having at least one cure site monomer and from about 60 weight percent to about 65 weight percent fluorine and a Mooney viscosity of from about 40 to about 80 ML₁₊₁₀ at 121 degrees Celsius,
(v) vinylidene fluoride/hexafluoropropylene/tetrafluoroethylene terpolymer fluoroelastomer having at least one cure site monomer and from about 66 weight percent to about 72.5 weight percent fluorine and a Mooney viscosity of from about 15 to about 90 ML₁₊₁₀ at 121 degrees Celsius,
(vi) tetrafluoroethylene/propylene copolymer fluoroelastomer having about 57 weight percent fluorine and a Mooney viscosity of from about 25 to about 115 ML₁₊₁₀ at 121 degrees Celsius,
(vii) tetrafluoroethylene/ethylene/perfluorovinyl ether/vinylidene fluoride tetrapolymer fluoroelastomer having at least one cure site monomer and from about 59 weight percent to about 64 weight percent fluorine and a Mooney viscosity of from about 30 to about 70 ML₁₊₁₀ at 121 degrees Celsius,
(viii) tetrafluoroethylene/perfluorovinyl ether copolymer fluoroelastomer having at least one cure site monomer and from about 69 weight percent to about 71 weight percent fluorine and a Mooney viscosity of from about 60 to about 120 ML₁₊₁₀ at 121 degrees Celsius, fluoroelastomer corresponding to the formula
[—TFE_{q}—HFPᵣ13 VdFₛ—]d
and
(ix) combinations thereof,
(x) wherein TFE is essentially a tetrafluoroethyl block, HFP is essentially a hexfluoropropyl block, and VdF is essentially a vinylidyl fluoride block, and products qd and rd and sd collectively provide proportions of TFE, HFP, and VdF whose values are within element 101 of FIG. 1.

27. The method of claim 19 wherein said providing provides structural polymer selected from the group consisting of acrylic acid ester rubber/polyacrylate rubber thermoplastic vulcanizate acrylonitrile-butadiene-styrene, amorphous nylon, cellulosic plastic, ethylene chlorotrifluoroethylene, epoxy resin, ethylene tetrafluoroethylene, ethylene acrylic rubber, ethylene acrylic rubber thermoplastic vulcanizate, ethylene-propylene-diamine monomer rubber/polypropylene thermoplastic vulcanizate, tetrafluoroethylene/hexafluoropropylene, fluoroelastomer, fluoroelastomer thermoplastic vulcanizate, fluoroplastic, hydrogenated nitrile rubber, melamine-formaldehyde resin, tetrafluoroethylene/perfluoromethylvinyl ether, natural rubber, nitrile butyl rubber, nylon, nylon 6, nylon 610, nylon 612, nylon 63, nylon 64, nylon 66, perfluoroalkoxy (tetrafluoroethylene/perfluoromethylvinyl ether), phenolic resin, polyacetal, polyacrylate, polyamide, polyamide thermoplastic, thermoplastic elastomer, polyamide-imide, polybutene, polybutylene, polycarbonate, polyester, polyester thermoset plastic, polyesteretherketone, polyethylene, polyethylene terephthalate, polyimide, polymethylnethacrylate, polyolefin, polyphenylene sulfide, polypropylene, polystyrene, polysulfone, polytetrafluoroethylene, polyurethane, polyurethane elastomer, polyvinyl chloride, polyvinylidene fluoride, ethylene propylene dimethyl/polypropylene thermoplastic vulcanizate, silicone, silicone-thermoplastic vulcanizate, thermoplastic polyurethane, thermoplastic polyurethane elastomer, thermoplastic polyurethane vulcanizate, thermoplastic silicone vulcanizate, thermoplastic urethane, thermoplastic urethane elastomer, tetrafluoroethylene/hexafluoropropylene/vinylidene fluoride, polyamide-imide, and combinations thereof.

28. The method of claim 19 wherein said admixing admixes conductive particulate selected from the group consisting of conductive carbon black, conductive carbon fiber, conductive carbon nanotubes, conductive graphite powder, conductive graphite fiber, bronze powder, bronze fiber, steel powder, steel fiber, iron powder, iron fiber, copper powder, copper fiber, silver powder, silver fiber, aluminum powder, aluminum fiber, nickel powder, nickel fiber, wolfram powder, wolfram fiber, gold powder, gold fiber, copper-manganese alloy powder, copper-manganese fiber, and combinations thereof.

29. The method of claim 19 wherein said admixing admixes fluoropolymer selected from the group consisting of fluoroelastomer vulcanized to provide a compressive set value from about 5 to about 100 percent of a mathematical difference between a non-vulcanized compressive set value for said fluoroelastomer and a fully-vulcanized compressive set value for said fluoroelastomer, fluoroelastomer thermoplastic vulcanizate vulcanized to provide a compressive set value from about 5 to about 100 percent of a mathematical difference between a non-vulcanized compressive set value for said fluoroelastomer of said fluoroelastomer thermoplastic vulcanizate and a fully-vulcanized compressive set value for said fluoroelastomer of said fluoroelastomer thermoplastic vulcanizate, fluoroelastomer-based thermoplastic elastomer vulcanized to provide a compressive set value from about 5 to about 100 percent of a mathematical difference between a non-vulcanized compressive set value for said thermoplastic elastomer and a fully-vulcanized compressive set value for said thermoplastic elastomer, and a blend of fluoroelastomer precursor gum and thermoplastic wherein said precursor gum has a glass transition temperature, a decomposition temperature, a Mooney viscosity of from about 0 to about 150 ML₁₊₁₀ at 121 degrees Celsius, and, at a temperature having a value that is not less than said glass transition temperature and not greater than said decomposition temperature, a compressive set value from about 0 to about 5 percent of a mathematical difference between a non-vulcanized compressive set value for fluoroelastomer derived from said fluoroelastomer precursor gum and a fully-vulcanized compressive set value for said derived fluoroelastomer; and
said admixing admixes conductive particulate selected from the group consisting of conductive carbon black, conductive carbon fiber, conductive carbon nanotubes, conductive graphite powder, conductive graphite fiber, bronze powder, bronze fiber, steel powder, steel fiber, iron powder, iron fiber, copper powder, copper fiber, silver powder, silver fiber, aluminum powder, aluminum fiber, nickel powder, nickel fiber, wolfram powder, wolfram fiber, gold powder, gold fiber, copper-manganese alloy powder, copper-manganese fiber, and combinations thereof.

30. The fuel line of claim 19 wherein said admixing further comprises admixing filler into said conductive fluoropolymer admixture, said filler selected from the group consisting of fiberglass particulate, inorganic fiber particulate, carbon fiber particulate, ground rubber particulate, polytetrafluorinated ethylene particulate, microspheres, carbon nanotubes, and combinations thereof.

31. The method of claim 29 wherein said fluoroelastomer is selected from the group consisting of
(i) vinylidene fluoride/hexafluoropropylene copolymer fluoroelastomer having from about 66 weight percent to about 69 weight percent fluorine and a Mooney viscosity of from about 0 to about 130 ML₁₊₁₀ at 121 degrees Celsius,
(ii) vinylidene fluoride/perfluorovinyl ether/tetrafluoroethylene terpolymer fluoroelastomer having at least one cure site monomer and from about 64 weight percent to about 67 weight percent fluorine and a Mooney viscosity of from about 50 to about 100 ML₁₊₁₀ at 121 degrees Celsius,
(iii) tetrafluoroethylene/propylene/vinylidene fluoride terpolymer fluoroelastomer having from about 59 weight percent to about 63 weight percent fluorine and a Mooney viscosity of from about 25 to about 45 ML₁₊₁₀ at 121 degrees Celsius,
(iv) tetrafluoroethylene/ethylene/perfluorovinyl ether terpolymer fluoroelastomer having at least one cure site monomer and from about 60 weight percent to about 65 weight percent fluorine and a Mooney viscosity of from about 40 to about 80 ML₁₊₁₀ at 121 degrees Celsius,
(v) vinylidene fluoride/hexafluoropropylene/tetrafluoroethylene terpolymer fluoroelastomer having at least one cure site monomer and from about 66 weight percent to about 72.5 weight percent fluorine and a Mooney viscosity of from about 15 to about 90 ML₁₊₁₀ at 121 degrees Celsius,
(vi) tetrafluoroethylene/propylene copolymer fluoroelastomer having about 57 weight percent fluorine and a Mooney viscosity of from about 25 to about 115 ML₁₊₁₀ at 121 degrees Celsius,
(vii) tetrafluoroethylene/ethylene/perfluorovinyl ether/vinylidene fluoride tetrapolymer fluoroelastomer having at least one cure site monomer and from about 59 weight percent to about 64 weight percent fluorine and a Mooney viscosity of from about 30 to about 70 ML₁₊₁₀ at 121 degrees Celsius,
(viii) tetrafluoroethylene/perfluorovinyl ether copolymer fluoroelastomer having at least one cure site monomer and from about 69 weight percent to about 71 weight percent fluorine and a Mooney viscosity of from about 60 to about 120 ML₁₊₁₀ at 121 degrees Celsius, fluoroelastomer corresponding to the formula
[—TFE_{q}—HFPᵣ—VdFₛ—]d
and
(ix) combinations thereof,
(x) wherein TFE is essentially a tetrafluoroethyl block, HFP is essentially a hexfluoropropyl block, and VdF is essentially a vinylidyl fluoride block, and products qd and rd and sd collectively provide proportions of TFE, HFP, and VdF whose values are within element 101 of FIG. 1.

32. The method of claim 19 further comprising coating, prior to said admixing, said conductive particulate with a coating to provide coated conductive particles as said conductive particulate, said conductive particles having a first surface tension between said conductive particles and said fluoropolymer, said coated conductive particles having a second surface tension between said coated conductive particles and said fluoropolymer, said second surface tension less than said first surface tension.

33. The method of claim 19 wherein essentially all of said conductive particulate admixed in said admixing comprises conductive particles independently having a cross-sectional diameter from about 0.1 micron to about 100 microns.

34. The method of claim 19 wherein said admixing is achieved with any of batch polymer mixer, a roll mill, a continuous mixer, a single-screw mixing extruder, and a twin-screw extruder mixing extruder.

35. A fuel line made by a process according to the method of claim 19.
